(19) United States
(12) Patent Application Publication
(10) Pub. No.: US 2025/0244926 A1
(43) Pub. Date: Jul. 31, 2025

(54) IMAGE FORMING APPARATUS, CONTROL METHOD, AND NON-TRANSITORY RECORDING MEDIUM

(71) Applicant: Takafumi NAKAMURA, Kanagawa (JP)

(72) Inventor: Takafumi NAKAMURA, Kanagawa (JP)

(21) Appl. No.: 19/012,880

(22) Filed: Jan. 8, 2025

(30) Foreign Application Priority Data
Jan. 29, 2024 (JP) 2024-011118
Jul. 10, 2024 (JP) 2024-111143

(51) Int. Cl. G06F 3/12; G06F 21/57

(52) U.S. Cl. CPC G06F 3/1236; G06F 3/1222; G06F 21/577; G06F 2221/033

(57) ABSTRACT

According to an embodiment of the present disclosure, an apparatus includes an operation device, an apparatus body, and circuitry. The operation device receives an operation by a user. The apparatus body operates based on a request from the operation device. The circuitry determines a vulnerability of software in the operation device. Based on a determination indicating that the software has a vulnerability, the circuitry restricts communication with the operation device in accordance with an attack risk due to the vulnerability.

### CROSS-REFERENCE TO RELATED APPLICATIONS

This patent application is based on and claims priority pursuant to 35 U.S.C. § 119 (a) to Japanese Patent Application Nos. 2024-011118, filed on Jan. 29, 2024, and 2024-111143, filed on Jul. 10, 2024, in the Japan Patent Office, the entire disclosures of each are hereby incorporated by reference herein.

### BACKGROUND

### Technical Field

The present disclosure relates to an image forming apparatus, a control method, and a non-transitory recording medium.

### Related Art

In the related art, an image forming apparatus includes an operation device and a body unit that have their own operation systems (OS) and operate independently of each other. Technologies for ensuring security have been proposed in the image forming apparatus having such a configuration.

Specifically, an information processing system includes an operation device that receives an operation by a user and a body unit that operates based on a request from the operation device. In the information processing system, the processing for verifying the validity and integrity of firmware necessary for activating the operation device is performed based on a request from the body unit. Accordingly, security is ensured.

### SUMMARY

According to one or more embodiments of the present disclosure, an apparatus includes an operation device, an apparatus body, and circuitry. The operation device receives an operation by a user. The apparatus body operates based on a request from the operation device. The circuitry determines a vulnerability of software in the operation device. The circuitry restricts communication with the operation device in accordance with an attack risk due to the vulnerability, based on a determination indicating that the software has a vulnerability.

According to one or more embodiments of the present disclosure, a control method performed by an apparatus including an operation device that receives an operation by a user, and an apparatus body that operates based on a request from the operation device, includes determining a vulnerability of software in the operation device to generate a determination result. The control method further includes restricting communication with the operation device in accordance with an attack risk due to the vulnerability based on the determination result indicating that the software has a vulnerability.

According to one or more embodiments of the present disclosure, a non-transitory recording medium storing a plurality of instructions which, when executed by an apparatus including an operation device that receives an operation by a user, and an apparatus body that operates based on a request from the operation device, causes the apparatus to perform a control method. The control method includes determining a vulnerability of software in the operation device to generate a determination result. The control method further includes restricting communication with the operation device in accordance with an attack risk due to the vulnerability based on the determination result indicating that the software has a vulnerability.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating an example of a hardware configuration of an image forming apparatus;

FIG. 2 is a diagram illustrating an example of communication performed by an image forming apparatus;

FIG. 3 is a diagram illustrating an example of communication restriction;

FIG. 4 is a flowchart illustrating an example of overall operation;

FIG. 5 is a flowchart illustrating an example of operation for determining a vulnerability;

FIG. 6 is a flowchart illustrating an example of operation for communication restriction;

FIG. 7A and FIG. 7B are diagrams illustrating examples of a screen display presenting a separation mode;

FIG. 8 is a diagram illustrating an example of a setting for permitting communication; and

FIG. 9 is a diagram illustrating an example of a functional configuration of an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure are described with reference to the drawings. The embodiments are not limited to the specific examples described below.

### Example of Image Forming Apparatus

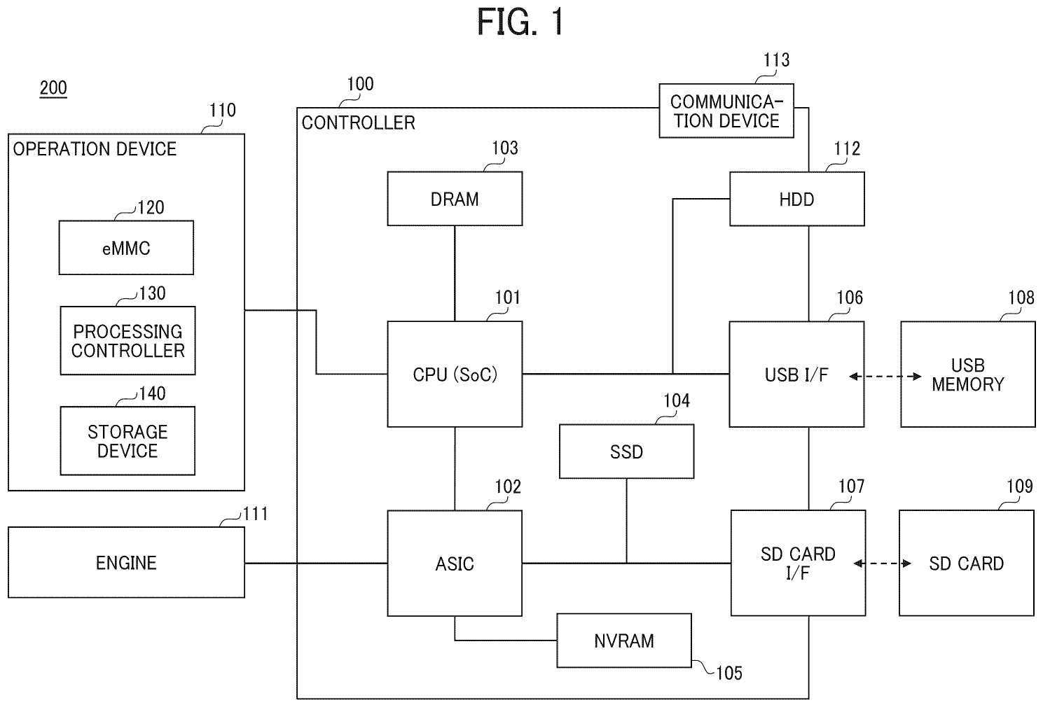

FIG. 1 is a block diagram illustrating an example of a hardware configuration of an image forming apparatus 200. For example, the overall operation of the image forming apparatus 200 is controlled by a controller 100.

The controller 100 includes a central processing unit (CPU) 101, an application-specific integrated circuit (ASIC) 102, a dynamic-random access memory (DRAM) 103, a solid state drive (SSD) 104, a non-volatile random access memory (NVRAM) 105, a secure digital card interface (SD card I/F) 107, a universal serial bus (USB) interface (USB I/F) 106, and a hard disk drive (HDD) 112.

The controller 100 further includes a communication device 113.

Into the SD card I/F 107, an SD card 109 is inserted. Similarly, into the USB I/F 106, a USB memory 108 is inserted.

For example, an operation device 110 and an engine 111 are connected to the controller 100 via a serial interface such as a USB cable.

The operation device 110 includes an input device such as a touch panel or a keyboard, and an output device such as a display. The operation device 110 displays, for example, an operation screen on the output device and receives an operation by a user via the input device.

The engine 111 includes, for example, a printer engine, a scanner engine, or a facsimile engine, and performs processing such as image formation.

The operation device 110 includes an embedded multi media card (eMMC) 120, a processing controller 130, and a storage device 140.

The eMMC 120 stores an operating system (OS), firmware, and an application for the operation device 110. Similarly, the HDD 112 stores the operating system and firmware for execution by the controller 100.

The processing controller 130 is a device that performs calculation and control. The processing controller 130 is implemented by, for example, a CPU.

The storage device 140 stores, for example, data in processing performed by the processing controller 130. The storage device 140 is implemented by, for example, a memory.

As described above, the firmware of the operation device 110 and the firmware of the controller 100 operate on different operating systems. Accordingly, the operation device 110 and the controller 100 are devices independent of each other. For example, the operation device 110 displays an operation screen or receives an operation by a user independently of the controller 100.

The HDD 112 is data storage storing, for example, print data, and has the capacity and failure resistance. Accordingly, the HDD 112 is included in the controller 100.

On the other hand, since the operation device 110 mainly serves as a user interface, the eMMC 120, which has excellent read/write speed to guarantee operability, is desirable to be included in the operation device 110. The controller 100 may include an SSD or an eMMC. Similarly, the operation device 110 may include an SSD or an HDD.

However, the hardware configuration is not limited to the above-described configuration. For example, the operation device 110 may include a calculation device, a control device, a storage device, an input device, an output device, or an auxiliary device other than the above-described devices inside or outside of the operation device 110. Similarly, the controller 100 may include a calculation device, a control device, a storage device, an input device, an output device, or an auxiliary device other than the above-described devices inside or outside of the controller 100. The image forming apparatus 200 may include, for example, a pre-processing apparatus or a post-processing apparatus.

The operation device 110 and the controller 100 are connected to each other via, for example, a USB I/F. The operation device 110 and the controller 100 perform communication based on a communication protocol such as transmission control protocol (e.g., TCP, IPv4, or IPv6) or user datagram protocol (UDP).

The communication device 113 performs communication via, for example, a local area network (LAN). The communication is performed wirelessly or by wire. Accordingly, the communication device 113 includes, for example, an integrated circuit (IC) for communication and a connector.

### Example of Performing Communication

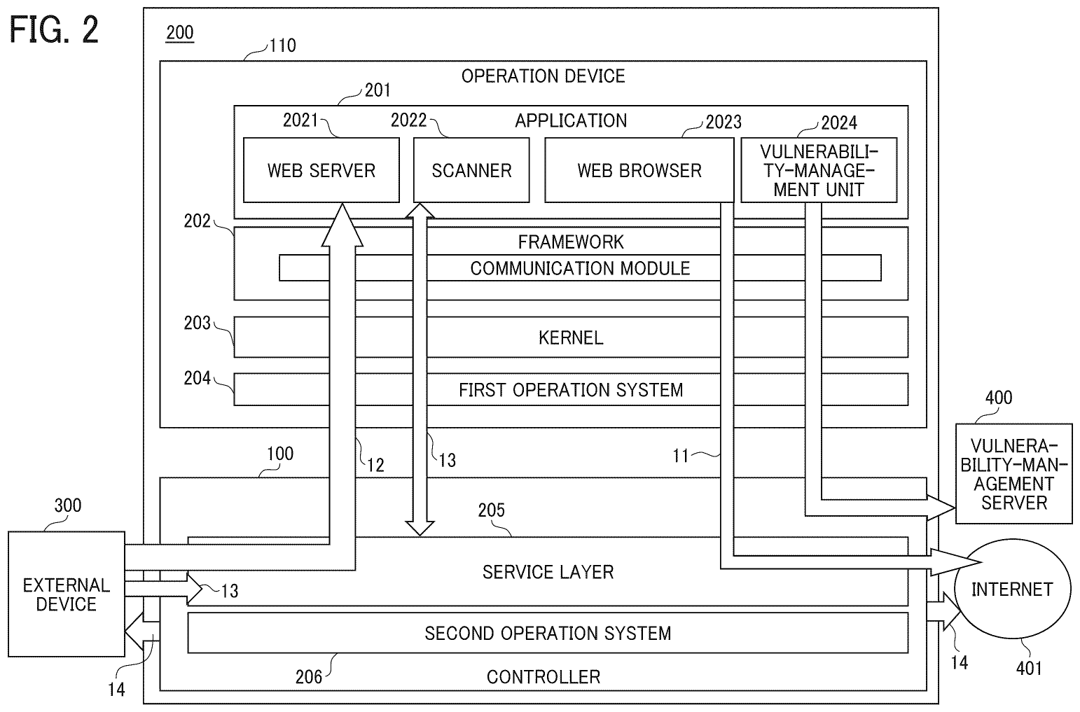

FIG. 2 is a diagram illustrating an example of communication performed by the image forming apparatus 200. For example, in the image forming apparatus 200, communication such as the first to fourth communication described below is performed between the operation device 110 and the controller 100.

In the operation device 110, software is installed in advance. In the operation device 110, an application 201, a framework 202, a kernel 203, and a first operation system 204 are implemented by the installed software.

The application 201 has various functions implemented by installing, for example, application software. Therefore, the application 201, in other words, the function to be performed by the image forming apparatus 200 is changed by installing other application software.

The framework 202 performs communication by, for example, a communication module.

The kernel 203 performs, for example, management of vulnerability.

The first operating system 204 is located between application software and hardware. The first operating system 204 provides an interface for a user and the application software, and implements, for example, resource management.

Similarly, in the controller 100, software is installed in advance. In the controller 100, a service layer 205 and a second operation system 206 are implemented by the installed software.

The first operation system 204 and the second operation system 206 are, for example, open source software (OSS).

For example, the application 201 implements functions of a web server 2021, a scanner 2022, a web browser 2023, and a vulnerability-management unit 2024.

The web server 2021 has a function of receiving access from the external device 300 to the operation device 110 via the controller 100.

The scanner 2022 has a function of instructing the image forming apparatus 200 to perform scan processing.

The web browser 2023 has a function of accessing the outside such as the Internet 401 from the operation device 110 via the controller 100.

The vulnerability-management unit 2024 has a function of determining a vulnerability. The operation device 110 performs communication for accessing, for example, a vulnerability-management server 400 in order to implement the vulnerability-management unit 2024.

The vulnerability-management server 400 includes, for example, a database indicating a vulnerability. Specifically, when the vulnerability-management server 400 is accessed, it is possible to determine what kind of vulnerability has occurred by collating with the database. By such determining, a risk to be attacked caused by the vulnerability is identified. In the following description, such a risk to be attacked may be referred to as an “attack risk.”

Hereinafter, the communication performed by the web browser 2023 is referred to as “first communication 11,” the communication performed by the web server 2021 is referred to as “second communication 12,” the communication to access the controller 100 is referred to as “third communication 13,” and the communication for the controller 100 to access an external resource is referred to as “fourth communication 14.”

The communication is not limited to the first to fourth communications, and other communications may be performed.

### Example of Communication Restriction

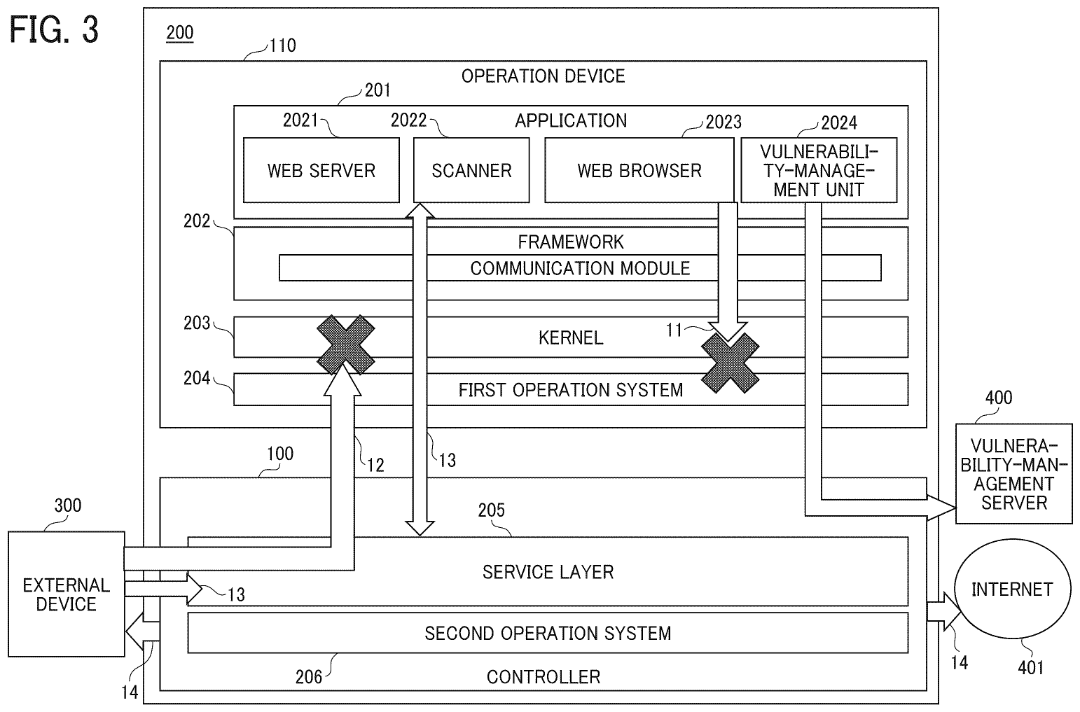

FIG. 3 is a diagram illustrating an example of communication restriction. Compared to FIG. 2, FIG. 3 differs in that some of the communications are restricted. Hereinafter, the points different from those of FIG. 2 will be mainly described, and a redundant description will be omitted.

For example, when it is determined that the first operation system 204 has a vulnerability, communication is restricted as follows in accordance with an attack risk.

Specifically, when it is determined that the first operation system 204 has a vulnerability, the first communication 11 and the second communication 12 are restricted. By restricting the communications as described above, the operation device 110 disconnects the communication between the operation device 110 and the network.

Hereinafter, a mode in which the operation device 110 is disconnected from the network in response to an occurrence of the attack risk is referred to as a “separation mode.” On the other hand, a mode in which the disconnection of the operation device 110 from the network is canceled is referred to as a “normal mode.” There may be three or more modes. In the following example, it is assumed that the operation device 110 transitions to the separation mode when it is determined that the first operation system 204 has the vulnerability.

In the separation mode, the kernel 203 disconnects the first communication 11, i.e., the communication for accessing, for example, the Internet 401 from the operation device 110 by the web browser 2023.

However, in the restriction of the first communication 11, the communication to a preset access destination may be excluded from a restriction target. Accordingly, even in the separation mode, the communication to the preset access destination may be permitted.

In the separation mode, the kernel 203 disconnects the second communication 12, i.e., communication for accessing the web server 2021 of the operation device 110 from an external source.

However, in the restriction of the second communication 12, the communication accessed from the external device 300 that is preset (hereinafter, referred to as a “registered device”) may be excluded from the restriction target. Accordingly, even in the separation mode, the communication with the registered device may be permitted.

On the other hand, even in the separation mode, the third communication 13 and the fourth communication 14 are permitted to be performed. Specifically, the third communication 13, i.e., the communication in which the operation device 110 accesses the controller 100 is permitted even in the separation mode. Similarly, the fourth communication 14, i.e., the communication in which the controller 100 accesses the Internet 401 is permitted even in the separation mode.

As described above, when it is determined that the software in the operation device 110 has a vulnerability, the operation device 110 transitions to the separation mode, i.e., communication is restricted by, for example, the kernel 203.

The operation device 110 having a vulnerability, i.e., having a high attack risk due to the vulnerability, may be attacked from, for example, an external source due to the vulnerability. Accordingly, to deal with the attack against the operation device 110, the communication is restricted and the operation device 110 is disconnected from the network. Therefore, an attack such as invading the operation device 110 via the network is prevented.

On the other hand, even in the separation mode, for example, the communication between the controller 100 and the operation device 110 is permitted. Accordingly, even in the separation mode, a user can use basic functions such as copying and scanning by using the image forming apparatus 200. Therefore, even in the separation mode, when the communication for using the basic functions of the image forming apparatus 200 is permitted, an excessive disconnection of data transmission and reception is prevented.

After a countermeasure such as patching is taken against the vulnerability, the operation device 110 transitions from the separation mode to the normal mode, and the operation device 110 cancels the disconnection of the operation device 110 from the network.

### Example of Overall Operation

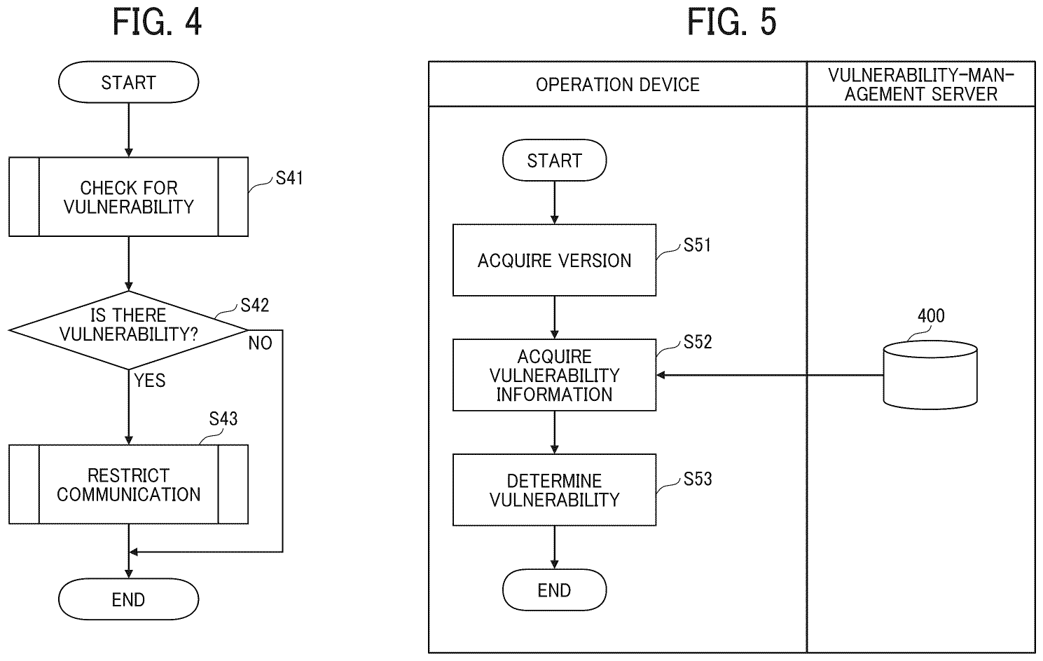

FIG. 4 is a flowchart illustrating an example of overall operation performed by the image forming apparatus 200. The operation of FIG. 4 is performed by, for example, the processing controller 130.

In step S41, the image forming apparatus 200 determines a vulnerability. For example, the step S41 is the processing described below.

FIG. 5 is a flowchart illustrating an example of operation for determining a vulnerability performed by the image forming apparatus 200. For example, the step S41 is performed periodically, for example, once a day.

In step S51, the operation device 110 acquires a version of software whose vulnerability is to be determined. For example, the operation device 110 acquires the version of the web browser 2023 from the web browser 2023.

In step S52, the operation device 110 acquires vulnerability information from the vulnerability-management server 400.

In step S53, the operation device 110 determines a vulnerability.

For example, in the vulnerability-management server 400, a database indicating a version having a vulnerability is implemented in advance. Accordingly, the operation device 110 acquires the current version and determines whether the same version is included in the database of the vulnerability-management server 400.

In the determination of the vulnerability, the operation device 110 may determine that the software has the vulnerability when the version is not the latest version (i.e., when the current version is older).

When the version corresponds to the database of the vulnerability-management server 400, the operation device 110 determines that the software has a vulnerability. On the other hand, when the version does not correspond to the database of the vulnerability-management server 400, the operation device 110 determines that the software does not have a vulnerability.

The database may indicate not only the presence of the vulnerability but also a score of the vulnerability. Whether the vulnerability is a high-level vulnerability equal to or higher than a certain level may be further determined based on the score.

Additionally, the vulnerability may be determined based on information other than the version. For example, the vulnerability may be determined based on, for example, a history of patching, or the statuses of various software.

In step S42, the image forming apparatus 200 determines whether the software has a vulnerability. When the image forming apparatus 200 determines that the software has a vulnerability (YES in step S42), the image forming apparatus 200 proceeds to step S43. On the other hand, when the image forming apparatus 200 determines that the software does not include a vulnerability (NO in step S42), the image forming apparatus 200 ends the overall operation.

When the image forming apparatus 200 determines that the software does not have a vulnerability (NO in step S42), the image forming apparatus 200 does not perform the communication restriction of step S43, i.e., maintains the normal mode instead of transitioning to the separation mode.

In step S43, the image forming apparatus 200 restricts communication. For example, the step S43 is the processing described below.

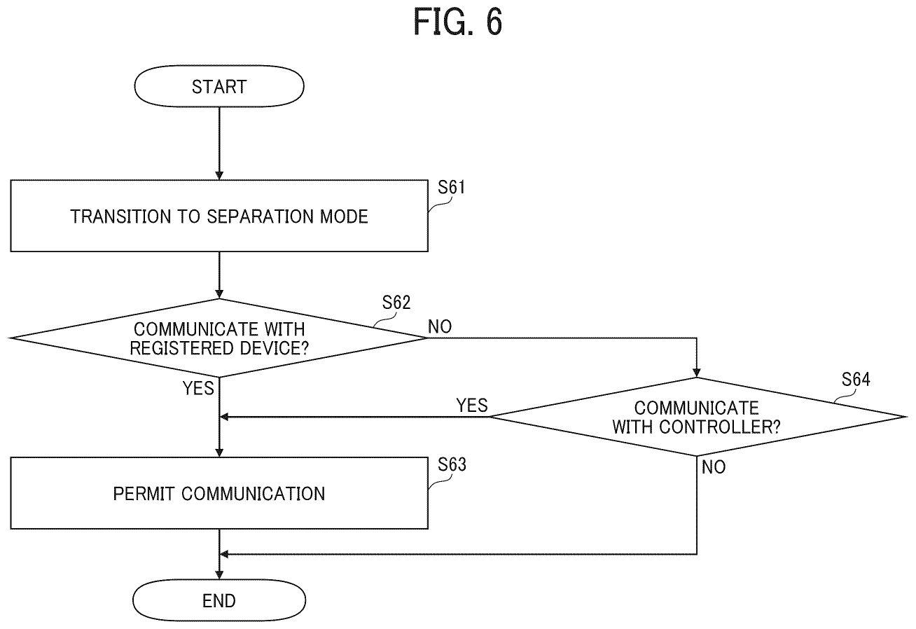

FIG. 6 is a flowchart illustrating an example of operation for communication restriction performed by the image forming apparatus 200.

In step S61, the image forming apparatus 200 transitions to the separation mode. Specifically, in the normal mode, the image forming apparatus 200 permits the first communication 11 to the fourth communication as illustrated in FIG. 2. On the other hand, in the separation mode, the image forming apparatus 200 restricts, for example, the first communication 11 as illustrated in FIG. 3.

In the separation mode, i.e., in a status where communication is restricted, the processing described below may be performed.

In step S62, the image forming apparatus 200 determines whether communication is performed with a registered device. When the image forming apparatus 200 determines that the communication is with the registered device (YES in step S62), the image forming apparatus 200 proceeds to step S63. On the other hand, when the image forming apparatus 200 determines that the communication is with a device other than the registered device (NO in step S62), the image forming apparatus 200 proceeds to step S64.

In step S63, the image forming apparatus 200 permits the communication with the registered device.

In step S64, the image forming apparatus 200 determines whether communication is performed with the controller 100. When the image forming apparatus 200 determines that the communication is with the controller 100 (YES in step S64), the image forming apparatus 200 proceeds to step S63. On the other hand, when the image forming apparatus 200 determines that the communication is not with the controller 100 (NO in step S64), the image forming apparatus 200 ends the overall operation while maintaining the separation mode.

As described above, even in the separation mode, the image forming apparatus 200 permits the communication with the controller 100 and the registered device. On the other hand, the image forming apparatus 200 restricts communication with devices other than the controller 100 and the registered device.

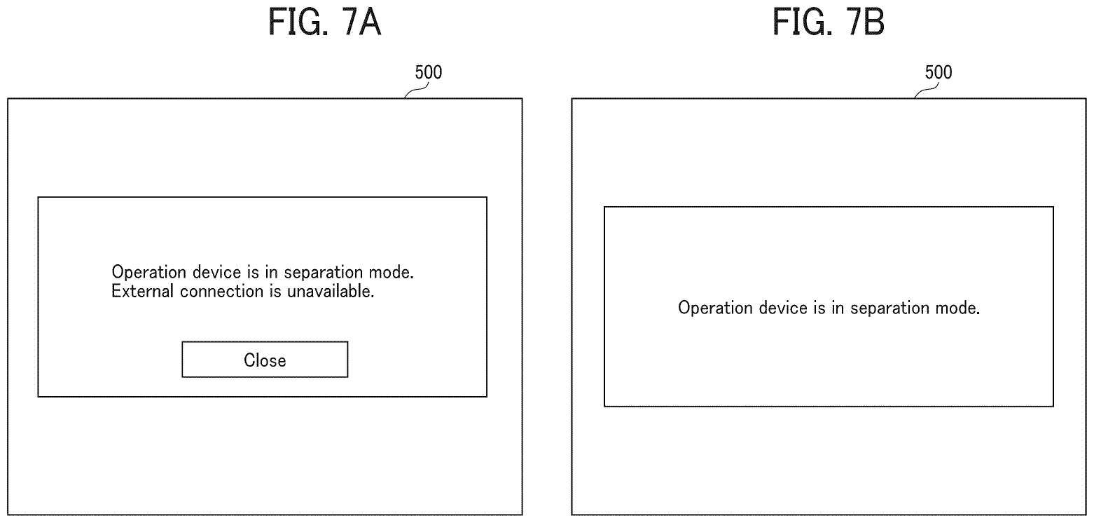

FIG. 7A and FIG. 7B are diagrams illustrating examples of a screen display presenting the separation mode. For example, the image forming apparatus 200 outputs a screen such as a display screen 500 illustrated in FIG. 7A or FIG. 7B on a display to notify a user of the current mode. The content of the display screen 500 may be notified to, for example, an external device via the Internet 401.

For example, the separation mode may be displayed on the screen by an image or text other than the display screen 500. Additionally, for example, the separation mode may be notified to a user by sound, light, vibration, or a notification such as an e-mail. For example, the notification by e-mail may be transmitted using Simple Mail Transmission Protocol (SMTP). In addition, the notification may be transmitted to, for example, the external device 300 by using Transmission Control Protocol/Internet Protocol (TCP/IP).

### Example of Setting for Permitting Communication

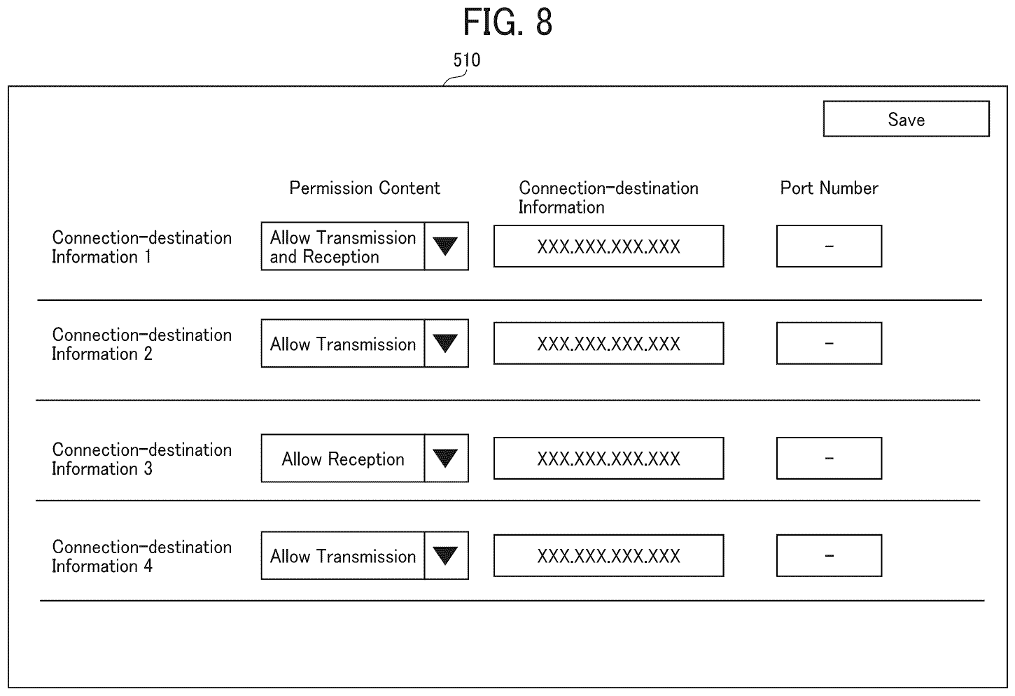

FIG. 8 is a diagram illustrating an example of a setting for permitting communication. For example, the connection destination with which communication is permitted even in the separation mode is set on, for example, a setting screen 510 described below.

Specifically, in the setting screen 510, when a user performs an operation of inputting “Permission Content,” “Connection-destination Information,” and “Port Number” for four connection destinations, the communications with the four connection destinations are permitted even in the separation mode.

The “Permission Content” is a setting item for permitting any one of “Transmission,” “Reception,” and “Transmission and Reception” even in the separation mode.

The “Connection-destination Information” is a setting item for specifying a connection destination by, for example, an Internet Protocol (IP) address. The connection destination may be specified by, for example, a device name or a physical address, instead of the IP address. The IP address may be, for example, an IPV6 address instead of an IPV4 address.

The “Port Number” is a setting item for specifying a port to be permitted to communicate.

When the connection destination is pre-registered on the setting screen 510 as described above, the registered connection destination specifies a registered device with which communication is permitted even in the separation mode.

As illustrated in the setting screen 510, even in the communication with the registered device, one of transmission and reception may be restricted. Furthermore, as illustrated in the setting screen 510, even in the communication with the registered device, a port to be restricted to communicate may be set.

### Example of Functional Configuration

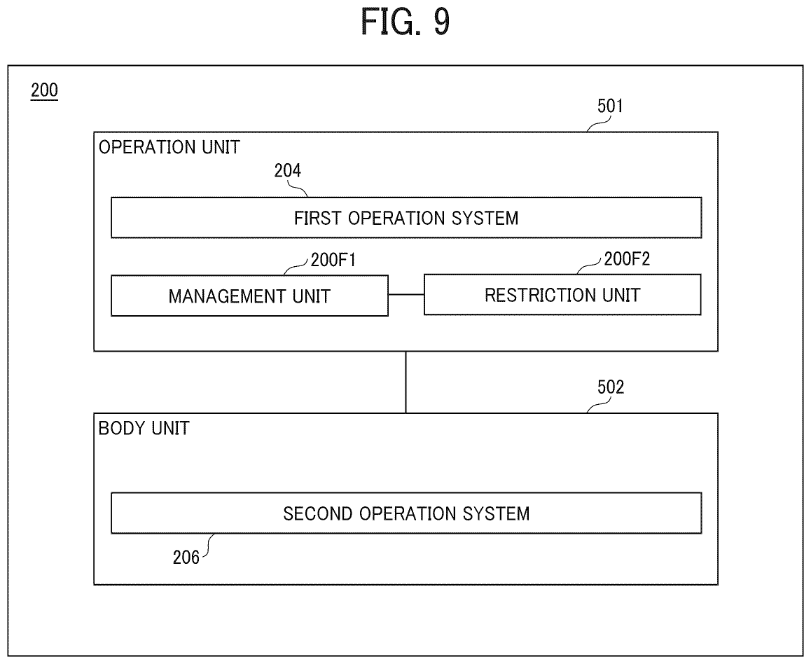

FIG. 9 is a diagram illustrating an example of a functional configuration of the image forming apparatus 200. For example, the image forming apparatus 200 includes an operation unit 501 and a body unit 502. The operation unit 501 corresponds to the operation device 110. The body unit 502 corresponds to an apparatus body of the image forming apparatus 200. The operation unit 501 includes a management unit 200F1 and a restriction unit 200F2.

The management unit 200F1 performs a management procedure for determining a vulnerability of software in the operation unit 501. For example, the management unit 200F1 is implemented by, for example, the processing controller 130. Additionally, the management unit 200F1 may be implemented by, for example, the CPU 101.

When the image forming apparatus 200 determines that the software has a vulnerability, the restriction unit 200F2 performs a restricting procedure for restricting communication with the operation unit 501 in accordance with an attack risk due to the vulnerability. For example, the restriction unit 200F2 is implemented by, for example, the processing controller 130. The restriction unit 200F2 may be implemented by, for example, the CPU 101.

With the above-described configuration, when a user operates the operation unit 501, the body unit 502 performs processing such as image formation based on a request from the operation unit 501.

As described above, the operation unit 501 and the body unit 502 have their own operation systems and operate independently of each other by their own different operating systems.

When the operation unit 501 has a vulnerability, the operation device 110 disconnects the operation unit 501 from the body unit 502 and restricts communication with the operation unit 501. Accordingly, restricting communication only with the operation unit 501 is performed. When a portion having a vulnerability is disconnected from the network, an attack using the vulnerability is prevented. Therefore, the security in the image forming apparatus 200 is enhanced.

On the other hand, since only the operation unit 501 and the network are disconnected, for example, the communication using the basic functions of the image forming apparatus 200 is permitted. As described above, an excessive interruption of data transmission and reception is prevented.

### OTHER EMBODIMENTS

The communication restriction may vary depending on the type of an attack risk. For example, the vulnerability may not be of a type related to communication. In such a vulnerability, even when communication is restricted, the attack risk is not reduced so much in many cases. Therefore, in the case of a vulnerability unrelated to communication, communication may not be restricted. As described above, restricting the communication according to the attack risk prevents a situation in which communication is restricted even when the attack risk is low.

The above-described control method may be implemented by a program. In other words, the above-described control method may be performed by an information processing apparatus including a calculation device and a storage device that operate in cooperation with each other based on a program.

The above-described control method may be performed by an information processing system. Accordingly, the information processing system may perform processing or storing related to the above-described control method in a distributed, parallel, or redundant manner. In an image forming apparatus according to the related art, countermeasures against security vulnerability related to, for example, software that operates after the activation is not sufficient. According to one or more embodiments of the present disclosure, the security in the image forming apparatus is enhanced.

Some aspects of the present disclosure are described below.

### Aspect 1

According to Aspect 1, an image forming apparatus includes an operation unit and a body unit. The operation unit receives an operation by a user. The body unit operates based on a request from the operation unit.

The image forming apparatus further includes a management unit and a restriction unit. The management unit determines a vulnerability of software in the operation unit.

The restriction unit restricts communication with the operation unit in accordance with an attack risk due to the vulnerability when the management unit determines that the software has a vulnerability.

### Aspect 2

According to Aspect 2, in the image forming apparatus of Aspect 1, the management unit determines a vulnerability of an operating system included in the operation unit.

### Aspect 3

According to Aspect 3, in the image forming apparatus of Aspect 2, the restriction unit disconnects the communication between the operation unit and a network in response to an occurrence of the attack risk in the operating system.

### Aspect 4

According to Aspect 4, in the image forming apparatus of Aspect 3, the restriction unit cancels the disconnecting the communication between the operation unit and the network when the attack risk that has occurred in the operating system is eliminated.

### Aspect 5

According to Aspect 5, in the image forming apparatus of any one of Aspects 2 to 4, the restriction unit causes the operation unit to transition to a separation mode in which the operation unit is disconnected from a network in response to an occurrence of the attack risk in the operating system.

In the separation mode, the restriction unit permits communication between a controller included in the body unit and the operation unit, and disconnects communication with a device other than the controller.

### Aspect 6

According to Aspect 6, in the image forming apparatus of any one of Aspects 2 to 4, the restriction unit causes the operation unit to transition to a separation mode in which the operation unit is disconnected from a network in response to an occurrence of the attack risk in the operating system.

In the separation mode, the restriction unit permits communication between a pre-registered device and the operation unit, and disconnects communication with a device other than the pre-registered device.

### Aspect 7

According to Aspect 7, in the image forming apparatus of any one of Aspects 2 to 4, the restriction unit causes the operation unit to transition to a separation mode in which the operation unit is disconnected from a network in response to an occurrence of the attack risk in the operating system.

Information indicating the separation mode is displayed on a screen.

### Aspect 8

According to Aspect 8, in the image forming apparatus of any one of Aspects 1 to 7, the operation unit and the body unit operate independently of each other by their own different operating systems.

The management unit determines the vulnerability by using a version of the operating system.

The present disclosure is not limited to the above-described examples of each embodiment. Accordingly, the present disclosure may be modified or added with components without departing from the technical scope of the present disclosure. Therefore, all technical matters included in the technical ideas described in the claims are included in the scope of the present disclosure. The above-described examples of the embodiments described above are specific examples suitable for implementation. In addition, those skilled in the art can implement various modifications from the disclosed contents, and such modifications are included in the technical scope described in the claims.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An apparatus comprising:
an operation device to receive an operation by a user;
an apparatus body to operate based on a request from the operation device; and
circuitry configured to:
determine a vulnerability of software in the operation device; and
restrict communication with the operation device in accordance with an attack risk due to the vulnerability, based on a determination indicating that the software has a vulnerability.

2. The apparatus according to claim 1,
wherein the circuitry determines a vulnerability of an operating system under which the software of the operation device operates, and determines the vulnerability of the software based on the vulnerability of the operating system.

3. The apparatus according to claim 2,
wherein the circuitry disconnects the operation device from a network in response to an occurrence of the attack risk in the operating system.

4. The apparatus according to claim 3,
wherein the circuitry re-connects the operation device to the network when the attack risk that has occurred in the operating system is eliminated.

5. The apparatus according to claim 2,
wherein the circuitry causes the operation device to transition to a separation mode in which the operation device is disconnected from a network in response to an occurrence of the attack risk in the operating system, and
wherein, in the separation mode, the circuitry enables communication between the apparatus body and the operation device, while disabling communication between the operation device and a device other than the apparatus body.

6. The apparatus according to claim 2,
wherein the circuitry causes the operation device to transition to a separation mode in which the operation device is disconnected from a network in response to an occurrence of the attack risk in the operating system, and
wherein, in the separation mode, the circuitry enables communication between a pre-registered device and the operation device, while disabling communication between the operation device and a device other than the pre-registered device.

7. The apparatus according to claim 2,
wherein the circuitry causes the operation device to transition to a separation mode in which the operation device is disconnected from a network in response to an occurrence of the attack risk in the operating system, and
the circuitry displays information indicating the separation mode on a screen.

8. The apparatus according to claim 1,
wherein the operation device and the apparatus body operate independently of each other by their own different operating systems, and
wherein the circuitry determines the vulnerability of the software based on a version of the operating system for the operation device.

9. The apparatus according to claim 1, further comprising:
an engine connected to the operation device and the apparatus body and to perform image formation.

10. The apparatus according to claim 1, wherein
the circuitry includes first circuitry operating on the operation device, and second circuitry operating on the apparatus body.

11. A control method performed by an apparatus including an operation device that receives an operation by a user, and an apparatus body that operates based on a request from the operation device, the method comprising:
determining a vulnerability of software in the operation device to generate a determination result; and
restricting communication with the operation device in accordance with an attack risk due to the vulnerability based on the determination result indicating that the software has a vulnerability.

12. A non-transitory recording medium storing a plurality of instructions which, when executed by an apparatus including an operation device that receives an operation by a user, and an apparatus body that operates based on a request from the operation device, causes the apparatus to perform a control method comprising:
determining a vulnerability of software in the operation device to generate a determination result; and
restricting communication with the operation device in accordance with an attack risk due to the vulnerability based on the determination result that the software has a vulnerability.
